(19) United States
(12) Patent Application Publication
(10) Pub. No.: US 2005/0111818 A1
(43) Pub. Date: May 26, 2005

(54) Light pipe bracket

(75) Inventors: Yen-lin Wang, Taipei (TW); Tzu-Huan Hsu, Taipei (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 10/995,881

(22) Filed: Nov. 23, 2004

(30) Foreign Application Priority Data
Nov. 24, 2003 (TW) TW92220723

(51) Int. Cl. G02B 6/00

(52) U.S. Cl. 385/147

(57) ABSTRACT

A light pipe bracket for supporting and protecting a light pipe in an optical engine system. The light pipe bracket includes a main body and a barricade. The main body supports and covers the light pipe, with an input end and an output end. The light pipe is bracketed by the input end and the output end. The barricade is disposed on the input end of the main body and shelters the light pipe to prevent light from the optical engine system from directly irradiating the light pipe and main body.

### BACKGROUND OF THE INVENTION

1. Field of the Invention

The present invention relates to a light pipe bracket, and in particular to a light pipe bracket that effectively resists radiant heat.

2. Description of the Related Art

Referring to FIG. 1, a projector generally includes an optical engine system 1 comprising an illumination device 11, a light pipe 12, an optical engine 13 and a projection lens 14. A bulb (not shown) is deployed in the illumination device 11. As shown in FIG. 1, the illumination device 11 is connected to the optical engine 13 via the light pipe 12, and the optical engine 13 is connected to the projection lens 14. The bulb in the illumination device 11 outputs light to the optical engine 13 via the light pipe 12. The optical engine 13 processes the light into images. The images are then projected out by the projection lens 14.

As shown in FIG. 2, the light pipe 12 generally comprises four (or more) reflective lenses 15. The reflective lenses 15 are bonded by glue to form a light input channel. When the bulb in the illumination device 11 outputs light beams, the light beams enter the light pipe 12 and become approximately parallel by total reflection of the reflective lenses 15. The parallel light beams then enter the optical engine 13. Accordingly, in order to adjust the incident angle or position of the parallel light beams entering the optical engine 13, the position of the light pipe 12 must be adjustable. As shown in FIG. 2, the position of the light pipe 12 can be adjusted by means of two bolts 16 and 17 deployed on the housing of the optical engine 13. Namely, the horizontal or vertical position of the light pipe 12 can be changed by the bolts 16 and 17 to obtain the proper incident angle or position of the parallel light beams entering the optical engine 13. Accordingly, the bolts 16 and 17 abut the reflective lenses 15 when the horizontal or vertical position of the light pipe 12 is changed, often damaging the reflective lenses 15. Thus, as shown in FIG. 2 and FIG. 3, a conventional metal light pipe bracket 18 covers the light pipe 12 such that the bolts 16 and 17 do not directly abut the light pipe 12, protecting the light pipe 12 from structural damage. Additionally, the light pipe 12 is fixed and supported by a retaining member 19. At least one spring (not shown) is disposed between the light pipe bracket 18 and the retaining member 19. The light pipe bracket 18 can protect the light pipe 12 from structural damage when the bolts 16 and 17 compress the spring.

Additionally, bulb power is increasingly promoted in accordance with demands for increasing brightness of the projector. Under this circumstance, the light pipe 12 and light pipe bracket 18 are directly exposed to irradiation from the high-powered bulb and thereby absorb excessive radiant heat. Accordingly, the temperature of the metal light pipe bracket 18 increases rapidly, exceeding operational limits thereof. Moreover, the glue between the reflective lenses 15 can melt or soften with the excessive radiant heat, with the light pipe 12 and optical engine system 1 damaged thereby.

### SUMMARY OF THE INVENTION

Thus, there is a need for an improved light pipe bracket providing enhanced support strength to the light pipe of the optical engine system, while resisting radiant heat from the bulb of the optical engine system. Accordingly, an object of the invention provides a light pipe bracket to support and protect a light pipe in an optical engine system. The light pipe bracket comprises a main body and a barricade. The main body supports and covers the light pipe, with an input end and an output end bracketing the light pipe therebetween. The barricade is disposed on the input end of the main body and shelters the light pipe to prevent light from the optical engine system from directly irradiating the light pipe and main body.

The barricade comprises a reflective material or is coated with a reflective material.

The main body and barricade are formed integrally and comprise a reflective material.

The main body and barricade are formed integrally and the barricade is coated with a reflective material.

The main body and barricade are formed integrally of metal and the barricade is coated with a reflective material.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic plane view of an optical engine system;

FIG. 2 is a schematic perspective view of a conventional light pipe bracket covering a light pipe;

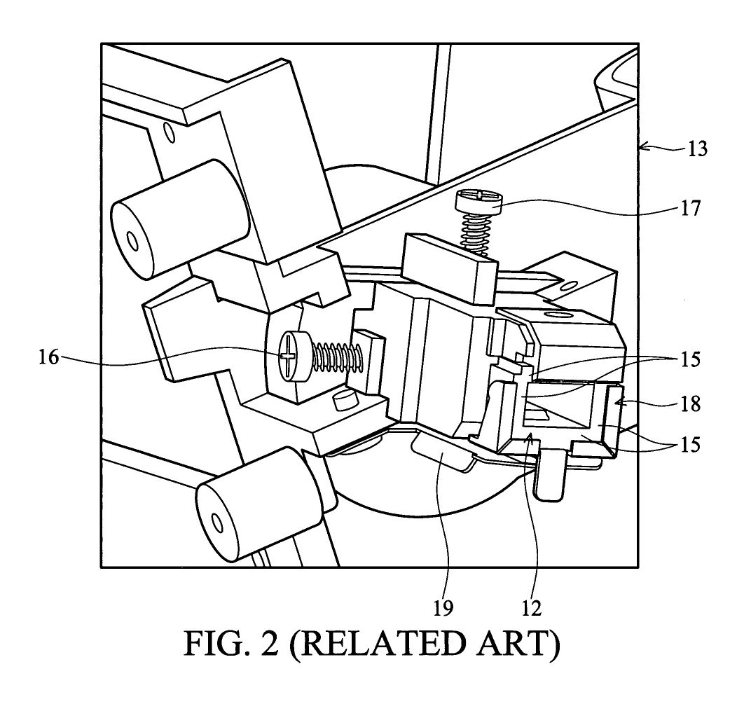

FIG. 3 is a schematic perspective view of the conventional light pipe bracket;

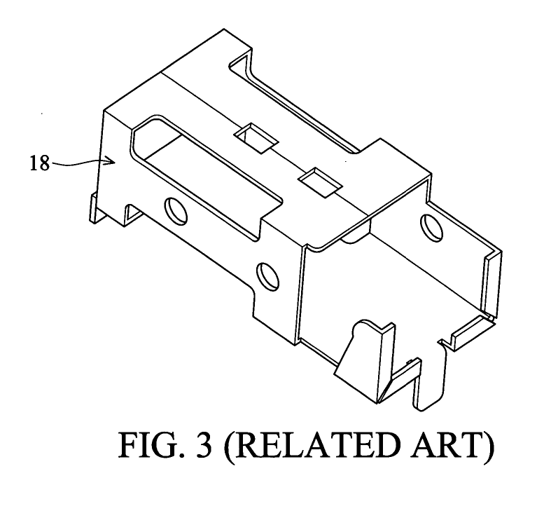

FIG. 4 is a schematic perspective view of the present light pipe bracket covering a light pipe; and

FIG. 5 is a schematic perspective view of the light pipe bracket of the invention.

### DETAILED DESCRIPTION OF THE INVENTION

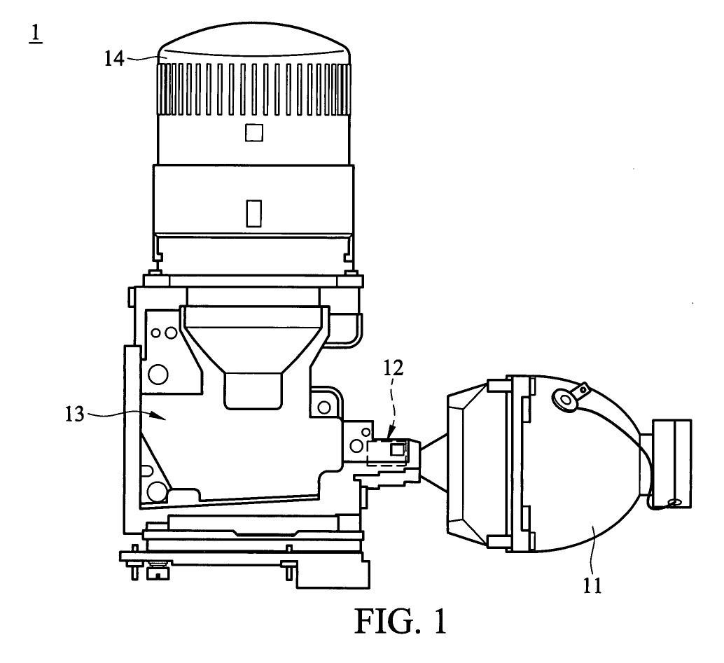

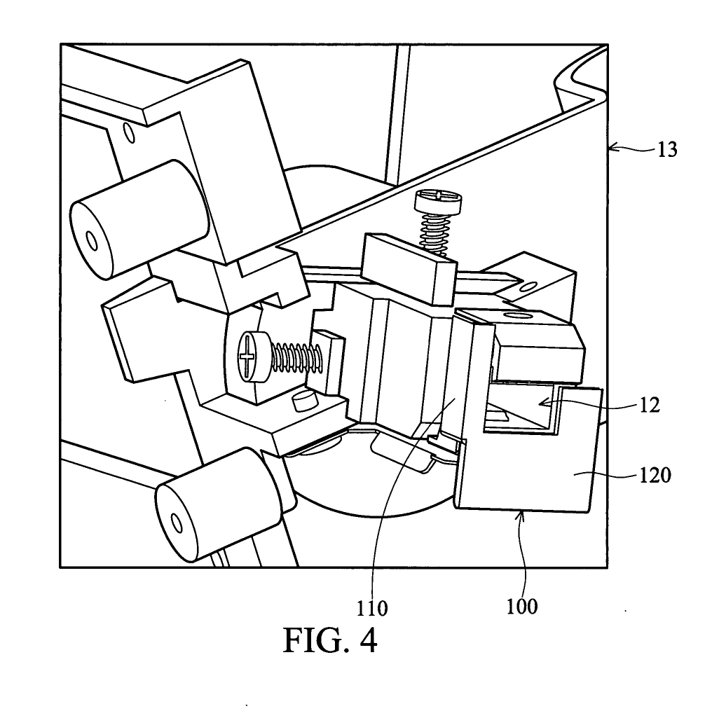

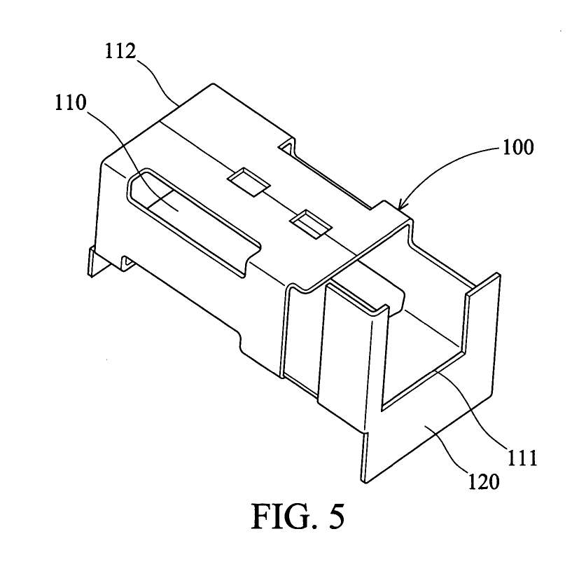

Referring to FIG. 4 and FIG. 5, the light pipe bracket 100 supports and protects a light pipe in an optical engine system. Specifically, the light pipe bracket 100 supports and protects the light pipe 12 connected to the optical engine 13, as shown in FIG. 1.

As shown in FIG. 5, the light pipe bracket 100 comprises a main body 110 and a barricade 120. The main body 110 comprises an input end 111 and an output end 112. The barricade 120 is disposed on the input end 111 of the main body 110. Specifically, the barricade 120 comprises or is coated with a reflective material. When light is irradiated on the barricade 120, the light is reflected by the barricade 120.

Additionally, the main body 110 and barricade 120 can be formed integrally. At this point, the main body 110 and barricade 120 comprise a reflective material, or the barricade 120 can be coated with a reflective material. Accordingly, the main body 110 and barricade 120 are formed integrally of metal and the barricade 120 is coated with a reflective material to enhance light reflection thereon.

As shown in FIG. 4, when the light pipe bracket 100 supports and protects the light pipe 12, the light pipe 12 is bracketed by the input end 111 and the output end 112 of the main body 110 and is supported and covered by the main body 110. Additionally, the barricade 120 disposed on the input end 111 of the main body 110 shelters one side of the light pipe 12. Accordingly, when the optical engine system outputs high-powered light to the light pipe 12 (input end 111 of the main body 110), the barricade 120 effectively resists (reflects) partial and redundant light. Namely, a part of the high-powered light is resisted (reflected) by the barricade 120 and the other part of the high-powered light passes the light pipe 12. Accordingly, the light pipe bracket 100 (main body 110) and side of the light pipe 12 are not directly irradiated by the high-powered light. Thus, the temperature of the light pipe bracket 100 (main body 110) is not increased excessively by the excessive radiant heat and structural damage thereof can thereby be prevented. Stability and reliability during operation of the optical engine system are thus enhanced.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

1. A light pipe bracket for supporting and protecting a light pipe in an optical engine system, comprising:
a main body supporting and covering the light pipe, with an input end and an output end, the light pipe bracketed by the input end and the output end; and
a barricade disposed on the input end of the main body and sheltering the light pipe to prevent light from the optical engine system from directly irradiating the light pipe and main body.

2. The light pipe bracket as claimed in claim 1, wherein the barricade comprises a reflective material.

3. The light pipe bracket as claimed in claim 1, wherein the barricade is coated with a reflective material.

4. The light pipe bracket as claimed in claim 1, wherein the main body and barricade are formed integrally and comprise a reflective material.

5. The light pipe bracket as claimed in claim 1, wherein the main body and barricade are formed integrally and the barricade is coated with a reflective material.

6. The light pipe bracket as claimed in claim 1, wherein the main body and barricade are formed integrally of metal and the barricade is coated with a reflective material.
